(19) United States
(12) Patent Application Publication
(10) Pub. No.: US 2015/0251593 A1
(43) Pub. Date: Sep. 10, 2015

(54) Vehicle Deceleration Warning Light

(71) Applicant: Wesley Zhou, Aliso Viejo, CA (US)

(72) Inventor: Wesley Zhou, Aliso Viejo, CA (US)

(21) Appl. No.: 14/198,324

(22) Filed: Mar. 5, 2014

(51) Int. Cl. B60Q 1/44; F21V 23/02; F21V 23/00; F21S 8/10

(52) U.S. Cl. CPC B60Q 1/444; F21S 48/20; F21V 23/02; F21V 23/003; F21Y 2101/02

(57) ABSTRACT

A vehicle license plate holder having a frame including a receptacle for a license plate, first and second LED light sources disposed on each side of the frame, and one or more power generators attached to the frame. The frame also mounts an electronic circuit module including a battery and configured to detect deceleration of a vehicle and to illuminate the first and second LED light sources in response to detection of the deceleration.

### BACKGROUND

1. Field of the Disclosure

The subject disclosure relates to vehicle safety devices and more particularly to a warning light for warning of sudden deceleration of a vehicle.

2. Related Art

Vehicle brake warning lights activated by brake depression are known in the art. However, they are ineffective in warning of quick deceleration which may occur without brake depression, such as may be experienced, for example, with motorcycles.

### SUMMARY

An illustrative embodiment of vehicle license plate holder according to the subject disclosure comprises a frame having a receptacle for a license plate, first and second LED light sources disposed on each side of the frame and one or more power generators attached to the frame. An electronic circuit module is located on the back of the frame and is configured to detect deceleration of a vehicle to which the license plate holder is attached and to illuminate the first and second LED light sources in response to detection of the deceleration. In one embodiment, the one or more power generators comprise first and second wind powered turbine generators positioned on respective sides of the license plate holder. In other embodiments, the one or more power generators comprise a solar power generator or a combination of solar power and wind turbine power generators.

In one illustrative embodiment, the electronic circuit module comprises an accelerometer chip coupled through an A/D converter to a controller circuit, a battery charging circuit, and switching circuitry configured to switch power to the first and second LED light sources. In such an embodiment, the controller circuit is configured to control the battery charging circuit and the switching circuitry. In one embodiment, the controller circuit may comprise a microprocessor.

### BRIEF DESCRIPTION OF THE DRAWINGS

FIG. 1 is a front perspective view of an illustrative embodiment;

FIG. 2 is a back perspective view of the embodiment of FIG. 1;

FIG. 3 is an enlarged fragmentary view of a portion of FIG. 1; and

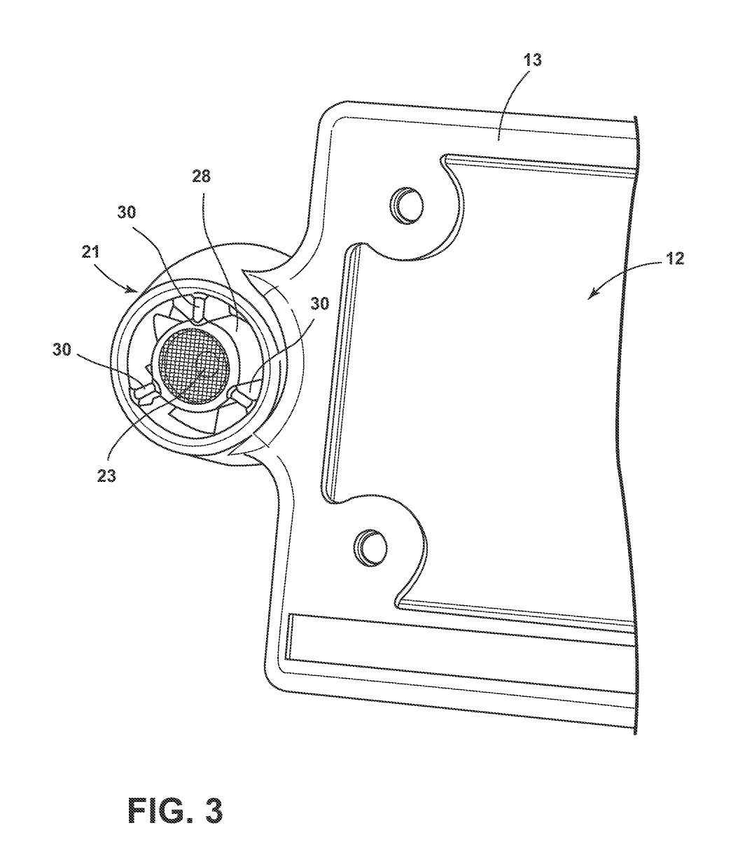

FIG. 4 is a schematic circuit diagram of electronic circuitry of an illustrative embodiment.

### DETAILED DESCRIPTION

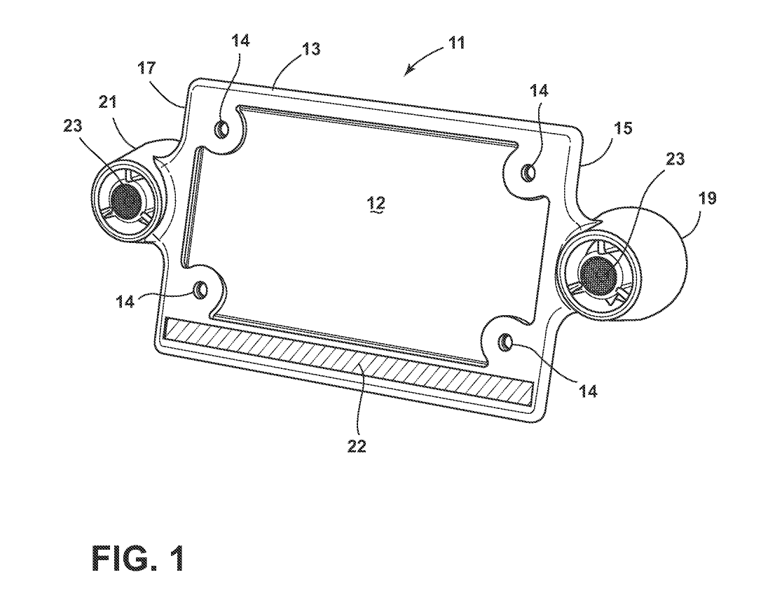

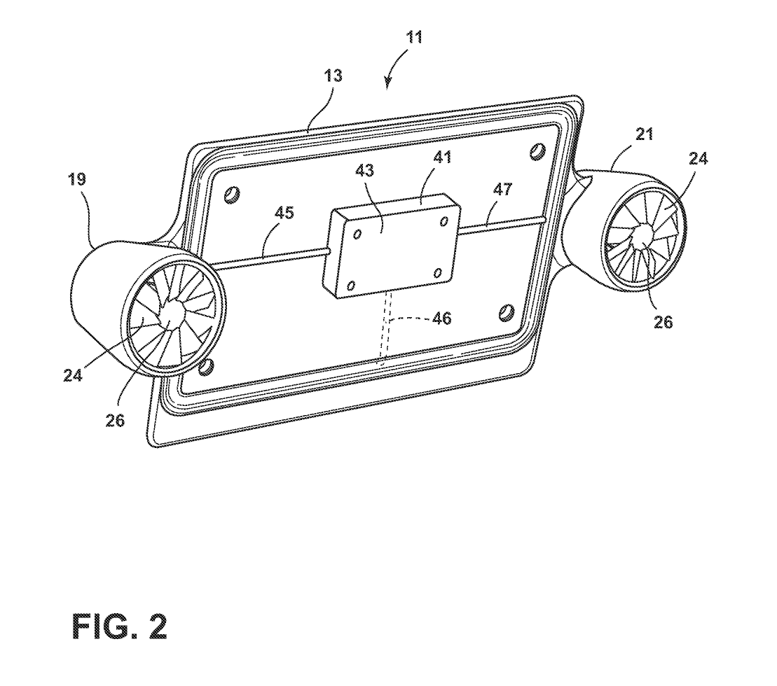

An illustrative embodiment of a vehicle warning light 11 is shown in FIGS. 1 and 2. The illustrative embodiment includes a license plate frame 13 for use on motor vehicles, which includes a receptacle 12 for receiving a license plate, as well as mounting holes 14. On the respective sides 15, 17 of the frame 13 are formed two air powered generators 19, 21 that generate DC current. A solar cell 22 may also be installed in the frame 13, or alternatively, in place of the generators 19, 21. Rear facing LED warning lights 23, which may comprise one or more LEDs, are centrally positioned on the turbine pods. In one embodiment, the device 11 is completely self-contained and has no external switches.

As seen in FIG. 2, the wind turbines 15, 19 include respective turbine blades 24 mounted on respective shafts 26 which are rotatably mounted in the central housing 28 of each turbine pod. Each central housing 28 is positioned and supported in the center of each pod by respective struts 30.

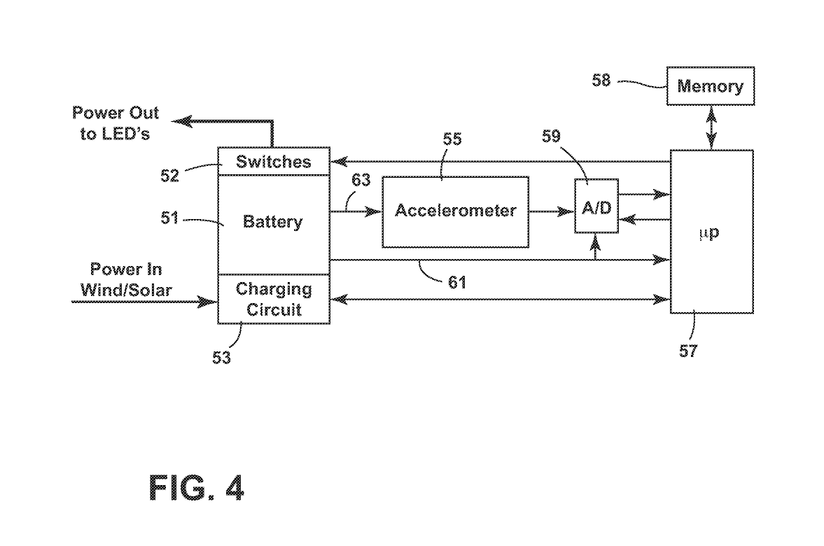

When the motor vehicle is moving, air flows through the turbine blades 24 which then spin to generate DC power. When the motor vehicle starts decelerating by either closing the throttle or applying the brakes an accelerometer S5 (FIG. 4) recognizes the deceleration and switches on the LED lights 23. As soon as DC power is applied, the system electronics (FIG. 4) autonomously begins monitoring the acceleration and deceleration of the motor vehicle. As soon as a forward deceleration situation is sensed the electronics will turn on the LED warning lights 23 until one of these situations occurs:

1. there is no more DC power available for powering the LEDs 23 and/or the electronics.

2. the forward deceleration is no longer occurring.

In one embodiment, as shown in FIG. 2, the electronics for controlling the LEDs 23 and power generators, e.g., 19, 22, is contained in a module 41, which may be molded as part of the license plate holder 13 or separately attached thereto. In one embodiment, the module 41 includes a removable water tight cover 43, which provides access to the electronics within the module. Suitable electrical leads or cables 45, 47 provide power to the LEDs 23 and transmit voltage from the power generators, e.g., 19, 21 to a rechargeable battery 51 located in the module 41. A lead 46 may transmit power from the solar cell 22 to the rechargeable battery 51. In one embodiment, the electrical leads or cables 45, 46, 47 may reside in channels or raceways which are pre-formed in the license plate structure and which may be covered and held in place by suitable covers or by epoxy or other methods. In an alternate embodiment, the electrical leads or cables may be installed during the molding process of a molded embodiment of the license plate holder and hence encapsulated in, for example, plastic or other molded material.

The electrical componentry within the module 41 is illustrated in FIG. 4. As shown, the componentry includes a battery 51, suitable switches 52 to control application of power to light the LEDs 23 and a battery charging circuit 53, which receives power from the power generators, e.g., 15, 19. In one embodiment, the battery 51 may be a lithium ion battery.

In an illustrative embodiment, the electrical componentry further includes an accelerometer chip 55 and a controller circuit, such as for example, a microprocessor or microcontroller 57, together with suitable memory 58. In one embodiment, the accelerometer chip 53 may be part no. ADXL330 as manufactured by Analog Devices, Inc., One Technology Way, Norwood, Mass.

The ADXL330 is a 3-axis accelerometer measurement system on a single monolithic IC, which has a measurement range of ±3 g minimum. It contains a polysilicon surface micromachined sensor and signal conditioning circuitry to implement an open-loop accelerometer measurement architecture. The output signals are analog voltages that are proportional to acceleration. The accelerometer can measure the static acceleration of gravity in tilt sensing applications as well as dynamic acceleration resulting from motion, shock, or vibration.

The sensor is a polysilicon surface micromachined structure built on top of a silicon wafer. Polysilicon springs suspend the structure over the surface of the wafer and provide a resistance against acceleration forces. Deflection of the structure is measured using a differential capacitor that consists of independent fixed plates and plates attached to the moving mass. The fixed plates are driven by 180° out-of-phase square waves. Acceleration deflects the moving mass and unbalances the differential capacitor resulting in a sensor output whose amplitude is proportional to acceleration. Phase-sensitive demodulation techniques are then used to determine the magnitude and direction of the acceleration.

In one embodiment, the demodulator output may be amplified and brought off-chip through a resistor. The user may then set the signal band-width of the device by adding a capacitor. This filtering improves measurement resolution and helps prevent aliasing.

In one embodiment, the outputs of the accelerometer 53 are A to D converted by converter 59 and supplied as inputs to the microprocessor 57. If the microprocessor 57 detects a sudden deceleration based on the accelerometer inputs, it causes power to be immediately supplied to the LEDs 23 via switches 52 to generate a warning light signal. Additionally, the microprocessor 57 monitors the charge state of the battery 51 and controls charging of the battery 51 by the auxiliary power supply sources. The battery 51 in turn supplies operating voltage on respective lines, e.g. 61, 63 to the microprocessor 55 and accelerometer 53. In some embodiments, suitable circuitry may be implemented to provide different operating voltages to different components.

Thus, those skilled in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

What is claimed is:

1. A vehicle license plate holder comprising:
a frame having a receptacle for a license plate;
first and second LED light sources disposed on each side of said frame;
one or more power generators attached to said frame; and
an electronic circuit module comprising a battery and configured to detect deceleration of a vehicle to which said license plate is attached, to illuminate said first and second LED light sources in response to detection of the deceleration, and to control charging of said battery by said one or more power generators.

2. The vehicle license plate holder of claim 1 wherein the one or more power generators comprise respective wind powered turbine generators positioned on respective sides of said license plate holder.

3. The vehicle license plate holder of claim 1 wherein said one or more power generators comprise a solar power generator.

4. The vehicle license plate holder of claim 2 wherein said one or more power generators further comprise a solar power generator.

5. The vehicle license plate holder of claim 1 wherein said electronic circuit module further comprises:
an accelerometer chip coupled through a A/D converter to a controller circuit;
a battery charging circuit;
switching circuitry configured to switch power to said first and second LED and light sources; and
wherein the controller circuit is configured to control the battery charging circuit and the switching circuitry.

6. The vehicle license plate holder of claim 4 wherein the controller circuit comprises a microprocessor.
